(19) United States
(12) Patent Application Publication
(10) Pub. No.: US 2024/0346450 A1
(43) Pub. Date: Oct. 17, 2024

(54) Automated Recruitment Interview Performance Assessment System

(71) Applicants: Kalpesh Parikh, Ahmedabad (IN); Sunanda Parikh, Ahmedabad (IN)

(72) Inventors: Kalpesh Parikh, Ahmedabad (IN); Sunanda Parikh, Ahmedabad (IN)

(21) Appl. No.: 18/298,472

(22) Filed: Apr. 11, 2023

(51) Int. Cl. G06Q 10/1053; G06V 40/16; G06V 40/20; H04L 9/40

(52) U.S. Cl. CPC G06Q 10/1053; G06V 40/172; G06V 40/20; H04L 63/0428; G10L 15/22

(57) ABSTRACT

ARIPA System gives feedback to improve interview skills. The Candidate ID (101 (a)) is established based on the recognition result between Server End System (108) and Candidate End System (103) which blocks fake identity based interviews. The interview feedback is based on various dimensions of core competency skill, soft skill, communication skill, and behavior aspects. Core competency is assessed based on the content of answers. System identifies the phrases used in the answer and matches with the Model Answer phrases. Non-Verbal Communication is evaluated based on: Verbal Content and language, Non Verbal: Voice and Gesture based and Understanding about questions. Server End System (108) generates Score Matrix as Per Defined Model Based on Assessment Outcome (224), prepares competency cards based on Fetched Comparative Data Matrix (303) in form of interview transcripts generated at end of interview. The Server End System (108) Stores all data in Block Chain Database (108 (d)).

### BACKGROUND OF THE INVENTION

Interviews are generally composed of interviewees who are evaluated through interviews and interviewers who perform evaluations of interviewees, consisting of interviewer questions and interviewees responses, and consist of a comprehensive evaluation of all questions and answers. All the industries are converted into Knowledge Industry. So the level of importance for quality of input e.g. Raw materials for manufacturing industries have the same importance, so capable intelligent manpower is required by all industries. With the rapid development of various industries, recruitment has become an important factor as in the prior recruitments, Human Resource (HR) departments are often required to screen resumes, the resumes are respectively appointed with interviewers and related post respondents for interviewing time. It has become very difficult to identify quality and skill as well as knowledge level of candidates based on text written on CV. In an increasingly competitive job market where candidates share similar skill sets and experience, the interview becomes the deciding factor in the hiring process and currently, individuals do not have the means to sufficiently practice job interviews. Individuals can practice interviews with a live person however many of them have very limited access to such a person due to cost, time and availability constraints. Inferior substitutes of the interview practices include interview question books, online sites with generic questions, interview tactic workshops, interview videos, and computer based training for a particular skill set.

The purpose of the interview is to grasp the interviewee's hard skills such as professional knowledge, expertise or information literacy, as well as soft skills such as the interviewee's attitude and communication ability through interaction in form of questions and answers. In addition, soft skills are areas that are judged differently according to the interviewer's subjective experience and intuition, and evaluation criteria and evaluation methods may vary depending on the interviewer. As described above, there is a problem in that it is difficult to objectively evaluate the interviewee's soft skills by the evaluation method that varies depending on the subjectivity of the interviewer.

In addition, in the case of soft skills, various factors exist, and it is very important to provide a result. It is necessary for the interview preparer to be able to grasp in detail what candidate is lacking as a whole, rather than simply evaluating extroverts or introverts. In addition, it is necessary to determine at what point during the interview there was a shortage, but there is no prior art where providing such a service.

On the other hand, many candidates are preparing for an interview, but it is difficult to provide objective evaluation results. In particular, in the case of soft skills, only evaluators with experience as various interviewers can make the correct evaluation. It is difficult to point out other people's soft skills. The purpose of the interview is to grasp the interviewer's hard skills such as expertise, expertise or information literacy as well as soft skills such as the interviewee's attitude and communication skills through questions and answers to come out with best fit for the purpose and position.

Most common current online methods offer MCQ related evaluation which provides far degraded evaluation of candidates.

In the existing method for evaluating the performance of the candidate, the grading result of the candidate is provided by utilizing image analysis, natural language processing, voice recognition and machine learning technologies. However, the existing method simply splices facial features, character answering features and voice features of interviewees, and finally scores position matching degree or interview performance with single dimension, so that feedback to the interviewee is lack of individuation and pertinence, the interviewee still cannot obtain effective interview feedback, and the interview performance of the interviewee is difficult to improve.

There is also a need for a technology driven system and method for candidates to pre-screen themselves to determine which jobs to apply for and to create additional resources for candidates to market themselves to employers. The present invention allows individuals to perform virtual interviews that can be analyzed for qualifications and submitted to employers for screening purposes.

An invention disclosed in patent application number US2004186743A1 discloses a system, method and software for individuals to experience an interview simulation and develop career and interview skills. It allows individuals to experience a full interview simulation, including pre- and post-interview stages. The invention allows individuals to communicate with a computer generated interviewer character. It simulates a discussion by speaking to the individual and asking the individual job-related questions, and displays output on the computer terminal and/or digitizes statements into speech. The individual responds to the statements by typing replies and/or speaking replies into a device such as a microphone, video camera or telephony device that receives and records the responses onto the system. Once the interview is complete, the individual can review all of own responses via a customized computer interface. The invention allows organizations to screen potential employees by conducting initial screening interviews. It allows individuals to self-screen by seeing which jobs they would be interested in and by submitting pre-screened data to employers. Finally, it allows individuals to train for interviews by going on realistic practice job interviews. The invention is able to provide detailed analysis and recommendations regarding the practice interviews to users, which assists them in developing career and interview skills.

An invention disclosed in patent application number CN111507680A discloses an online interview method, system and device and a storage medium, and the method comprises the steps: receiving an interview request from a first terminal, the interview request comprising interviewer information and interview posts; matching from a question bank according to the interview post to obtain an interview question, pushing the interview question to the first terminal, and obtaining an interview video from the first terminal; matching corresponding auditors in an auditor information base according to the interview posts, pushing the interview questions and the interview videos to second terminals of the auditors, and obtaining first evaluation data from the second terminals; and generating an interview conclusion according to the first evaluation data. By the adoption of the scheme, the online interview platform is provided, interview questions are automatically selected for an interviewer, interview videos are automatically matched and sent to auditors, interview efficiency is improved, and interview manpower and time cost are saved.

An invention disclosed in patent application number CN113095165A discloses a simulation interview method and a simulation interview device for perfecting interview performance, and belongs to the technical field of audio and video processing. The method comprises the following steps: establishing an interview database; acquiring audio data and image data of an interview, converting the audio data into character information, extracting the audio information from the audio data, and extracting the image information from the image data; analyzing the character information, the audio information and the image information to respectively form a character vector, an audio matrix and an image matrix of the interview answer; comparing the answer key words corresponding to the questions in the question bank with the text vectors, the audio matrix and the image matrix of the interview answers according to the question bank, the behaviour attention key point table and the ability requirement table of the interview post to obtain the correlation coefficient and/or the distance parameter of the interview post and the answer key words corresponding to the questions in the question bank; and converting the correlation coefficient and/or the distance parameter into interview opinions and suggestions. The invention provides post-specific improvement opinions by analysing the behaviour characteristics of the interviewer in the aspects of limb movement, facial expression and speaking mode.

There is, therefore, a need for a technology driven system and method for individuals to rehearse their interviewing skills. The present invention allows individuals to practice, develop, and offer areas which need to refine their interviewing skills. Individuals can practice an interview as many times as they wish from any location with access to an ICT device.

Further to this, great resignations lead to bulk hiring of manpower in giant corporations, many times thousands of candidates are required to be properly assessed and recruited in a very short period of time. In such conditions, it is really difficult for the Human Resource team of said corporations to execute selection of right candidates at needed quality and pace. This calls for a great input of ICT platforms which can automate the entire recruitment interview performance assessment process in an intelligent way, which can match the quality and pace required by the business to fulfill its objectives. This requires conceptualization of the ICT based smart and an intelligent Recruitment Factory, who can fulfil above mentioned demands. The present invention offers an innovative solution for an Automated Recruitment Interview Performance Assessment (ARIPA) System.

The present novel invention Automated Recruitment Interview Performance Assessment (ARIPA) System, is an interview performance assessment automated system. The present novel invention provides identity proven interviews in which candidate's identity is established by combination of the voice recognition and face recognition by matching with registered voice and face at the time of registration process.

The present novel invention provides core competency, verbal and non-verbal communication evaluation based on the content of the answers for the questions asked by the system and the system will identify the phrases used in the answer given by interviewee. The said phrases will be matched with the model answer phrases. System checks whether phrases used in answers are identified as part of the correct answer, wrong answer phrases, irrelevant phrases (i.e. not related to the question asked at all), not part of a set of any phrases. The present novel system generates a score for answer by addition for the values identified against each of the defined categories above for each question in the block chain database.

The present novel invention also provides comparative evaluation (competitiveness evaluation) as all the conventional systems do not provide the performance of the Interviewee.

The present novel system offers comparative performance of a candidate's own multiple interview.

It also offers comparative performance of candidate's interview with peers in the Institute from the same batch, other institutes from the same city, toppers in the complete database for the same year student, senior batches students for the same set or based on other parameters as per need of the user.

All the data related to scoring and verbal as well as nonverbal communications are presented in matrix for self-evaluation.

In one novel aspect of the present invention, the adaptive recruitment domain as well as subject matter technical experts generate a question bank based on a job description. Subject matter experts will design and define the questions for each role, along with sequence of asking the questions. They will define the correct answer for each question. Difficulty level of the question will be defined by them for each category. Fresher Candidate, Experience Candidate, Local Company, Department of MNC, Giant company of vertical etc. Keyword Phrases will be identified for different aspects like Key Phrases, Minimum expected phrases in answer, phrases not expected in answer, phrases not relevant for answer. A Profile of SME will also be captured and an option will be there to know the details by the user of the system to build credibility of question and answers. Periodically SME will validate the complete set of assessment by adding, deleting and/or modifying questions and answers as per the advancement of the subject.

Present novel system selects questions adaptively from the question bank during an interview with the candidate, and generates a feedback report for the candidate based on the evaluation of the candidate's answers. Candidates will get feedback from the system about their own performance in the interview. Feedback is based on various dimensions of core competency skill, soft skill, communication skill, and behavior aspects. Candidates can replay the interview for self-analyzing. Candidates can schedule their interview any time as per their convenience and perform as many times as required.

Candidates can also share a link of the interview with its performance analysis to various institutes additionally or as replacement of CV to demonstrate competency level. Candidates can also share link to mentor for evaluation of the performance

Present invention becomes really effective from the candidate's point of view, that outcomes offered by the system remain only available for the eyes and ears of the candidate. Thus there is no fear for the candidate, that someone will come to know about the candidate's weakness, and hence there is no scope for embarrassment.

Present invention become really effective from the organizations point of view also, that they can cut down processes based on interview links shared to them, they can conduct unlimited interviews every day. Bottle neck of availability of candidate and expert combination is eradicated. They can get a standard view of each candidate as the system is going to assess them without limitations of human beings like bias, subjective, following shortcut as per availability of time etc.

Present invention offers an integration of various technologies for a given narrow focused purpose, and is the key to address said problems. In the present invention Data Security, Data Privacy and Data integrity are taken care of by use of right technology like block chain, device specific access, encryption of data and use of varied novel algorithms in encrypting the data.

### Objectives of Invention

Primarily the objectives are in two main categories namely (1) Candidates—i.e. Interviewee and (2) Organizations-who are interested in assessment of interviewee.

### Candidate Focused Objectives

Principal objective of the present invention is to provide an interview performance assessment automated system for providing interactive interviews, and interview preparation in which a candidate gets an evaluation outcome that allows the candidate to grasp the status and identify scope for improvement.
Another objective of the present invention is that the evaluation is based on various dimensions of core competency skill, soft skill, communication skill, and behavior aspects.
Further objective of the present invention is that the candidate also gets a comparative performance of their own multiple attempts of interviews.
Another objective of the present invention is that the candidate is able to get the feedback on comparative performance with peers, candidates of the other institutes, toppers and many such other combinations.
Further objective of the present invention is that the candidates can replay the interview and analyze on their own.
Further objective of the present invention is to provide candidates to assess their own readiness and level of competency for the given role.
Another objective of the present invention is that it eliminates third party involvement as it happens between system and candidate, which leads to the highest level of privacy.
Further objective of the present invention is that the candidate can schedule an interview any time as per their own convenience and perform as many times as required.
Further objective of the present invention is that the candidate can share the link of own interview with its performance analysis to various institutes as replacement of own CV to prove competency level.
Another objective of the present invention is to provide a system in which one candidate can perform more than one role interview, which will enable candidates to identify that out of aspired multiple roles, in which role the candidate has highest level of the competency.
Another objective of the present invention is that the candidate can suggest rephrasing the question for better understanding.
Further objective of the present invention is that the candidate can ask for explanation or repeat the question so that it can be articulated in an effective manner.
Further objective of the present invention is that the candidate can seek help from a mentor on improvement of his interview performance.
Further objective of the present invention is that the candidate can configure difficulty level by choosing from available options like Local Company, Giant Corporate, MNC etc to assess competency fitness level.

### Organization Focused Objectives

Another objective of the present invention is to provide an institutionalized interview assessment process as it transforms from person driven assessment to system driven assessment, which also transforms from perception driven assessment to data driven assessment.
Another objective of the present invention is to eliminate limitations on the number of interviews that can be conducted in given time.
Further objective of the present invention is that it offers an ICT based smart and an intelligent Recruitment Factory to the corporates which is capable of assessing the candidates for recruitment of thousands of candidates in a short time interval with minimal human intervention.
Another objective of the present invention is that it offers an ICT based smart and an intelligent Recruitment Factory wherein the recruiting companies have configuration capabilities to define the benchmark value for each competency parameter for different job profiles and for same job role over different time period, so as to shortlist the candidate for maintaining their quality level of input and which also offers much higher speed of assessment for recruitment.
Further objective of the present invention is that it offers a system wherein the initial layer of interview round and multiple limitations like number of candidates, availability of number of interviewers to conduct interview and such other aspects can be eliminated. This will help organizations to trim down the interview process cycle, cost of interview, gap arising out of different human interviewers.
Further objective of the present invention is that it offers a novel system wherein the organization gets an assessment report and recorded interview of the candidate, which was performed by candidate at—independent level, in addition or in lieu of candidate's CV. Thus assessment comes to organization as input for decision facilitation rather than generating as output through manual recruitment assessment process.
Further objective of the present invention is that the recruiting companies are able to define and configure at least one and more of the whole set of questions, answers, key words and phrases specific to said questions and answers, score/ranking for each of the said phrases, evaluation methods, range for the verbal and non-verbal assessment for their personalized and customized need. In such a way that there will not be any difference in assessment of candidate between this system and human interview panel of the organization.

### FIELD OF INVENTION

The present invention relates in general to the field of interactive System and interview Information and Communication technology (ICT) devices along with audio and video processing, where system is able to listen and see like a human, reaching to consider that system have digital ear and eyes, more particularly to a system, method and candidate assessment and evaluation tool for performing interactive interviews, and mock interview at real life style and scale. While interviewing, next questions come based on the answers by detecting physiological or emotional reactions of the candidate. A candidate evaluation tool gives feedback that can improve candidate's interview skills more intuitively, to assess the current competences and calibrate the competences after bridging the identified gaps through own external interventions. This eradicates the need for a traditional CV as candidates will be able to share interviews with employers or mentors. This will invoke a new model or method of connection between Employer and candidate (Prospective Employee). Present invention is related to the candidate interview assessment/evaluation system without any human intervention. The present invention provides an evaluation report like a pathological test report as a fact sheet with bench mark parameters. This facilitates the interviewee to identify the areas which need improvement.

### SUMMARY OF THE INVENTION

The present novel invention Automated Recruitment Interview Performance Assessment System, is an interview performance assessment automated system. The present novel invention provides identity proven interviews in which candidate's identity is established. The present novel invention provides core competency, verbal and non-verbal communication evaluation based on the content of the answers for the questions, and the system will identify the phrases used in the given answers. The present novel system generates a score for given answers by addition for the values identified against each of the defined categories for each question in the block chain database. The present novel invention also provides comparative evaluation (competitiveness evaluation). The present novel system offers comparative performance of a candidate's own multiple interview. All the data related to scoring and verbal as well as non-verbal communications are presented in the matrix form for self-evaluation. Candidates will get feedback from the system about their own performance in the interview. Feedback is based on various dimensions of core competency skill, soft skill, communication skill, and behaviour aspects. Candidates can replay the interview for self-analysing purposes. Candidates can schedule their interview any time as per their convenience and perform as many times as required. Candidates can also share a link of a recorded interview with its performance analysis to various institutes as additional or replacement of CV to demonstrate competency level. Further objective of the present invention is to provide candidates to assess their own readiness and level of competency for the given role. Another objective of the present invention is that it eliminates third party involvement as it happens between system and candidate, which leads to the highest level of privacy.

### LIST OF THE COMPONENTS REFERRED IN SPECIFICATIONS AND DRAWINGS

101. Candidate
101 (a). Candidate ID
102. Candidate ICT Device with Camera, Speaker and Microphone
103. Candidate End System
104. Fetch Candidate ICT Device ID at Hardware Level
104 (a). Candidate has to read and speak the content displayed on the screen.
104 (b). System records voice and video of candidate while speaking the content
104 (c). Transmit Voice, Video and Candidate ICT Device Id through Network
105. Perform Candidate's Audio and Video Encryption
106. Transmits the encrypted voice and video through the Network
107. Server
108. Server End System
108 (a). Store Registered Candidate ICT Device Id to Block Chain Database
108 (b). Store Candidate Audio and Video in Block Chain Database
108 (c). Candidate ID is created by Server End System as Unique Identity
108 (d). Block Chain database
109. Fetch Registered Candidate ICT Device Id from Block Chain Database
110. Perform Decryption of Candidate's Audio and Video
111. Fetch Candidate's Registered Voice and Face from Block Chain Database
112. Process for Voice Recognition
113. Process for Face Recognition
114. Revert the Server Result for Identity to Candidate End System
115. Server Will Not Initiate Interview Process
116. Server will start interview process
201. Candidate Starts Interview
202. Candidate Identity Establishment
203. System to Fetch Question in Text Form from Block Chain Database
204. Server End System to Process Question in Text Form to Question in Voice Form
205. Server End System to Encrypt the Voice Question by Applying Candidate ICT Device Id as Key
206. Server End System to Transmit Encrypted Question to Network
207. Candidate ICT Device to Receive the Encrypted Voice Question
208. Candidate End System to Fetch Candidate ICT Device Id at Hardware Level
209. Candidate End System to Decrypt the Question Applying Fetch Candidate ICT Device Id
210. Speaker to Play the Question on Candidate ICT Device
211. Candidate to Answer the Question in voice
212. Candidate ICT Device Mike to Receive the Audio Answer
213. Candidate ICT Device Camera to Receive the Video While Answering
214. Candidate End System to Generate Encrypted Audio and Video and Send to Server
215. Server End System to Receive Encrypted Audio and Video
216. Server End System to Decrypt Audio and Video
217. Candidate identity Re-Establishment
218. Server End System to Process Answer in Audio Form to Answer in Text Form
219. Server End System to Fetch Correct Answer in Text Form from Block Chain Database
220. Server End System to Assess the Answer as Per Assessment Model
221. Server End System to Carry out the Audio Analysis
222. Server End System to Carry out the Video Analysis
223. Server End System to Perform Understanding Assessment
224. Server End System to Generate Score Matrix as Per Defined Model Based on the Assessment Outcome
225. Server End System to Store the Audio, Video, Core Competency Assessment Result, Understanding Assessment, Audio Assessment and Video Assessment in to the Block Chain Database
301. Candidate Finishes the Interview
302. Process Comparative Ranking
302 (a). Identity the Batch mate topper
302 (b). Identity the City topper
302 (c). Identity the overall topper
302 (d). Identity the topper based on custom configurability provided in system
302 (e). Identify previous Interviews of the Candidate
302 (f). Server End System fetches the interview performance data for all identified as above
303. Prepare Competency Card Based on Fetched Comparative Data Matrix
304. Save Competency Card in Block Chain Database
305. Server End System to Create an Encrypted Competency Card
306. Server pushes these data on network to Candidate end system
307. Candidate to View the Competency Card in Candidate End System

### BRIEF DESCRIPTION OF DRAWINGS

### List of Drawings:

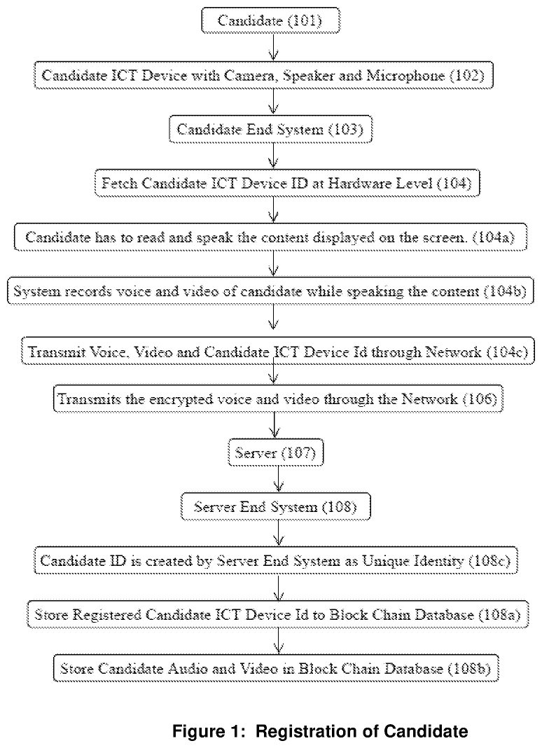

FIG. 1: Registration of Candidate

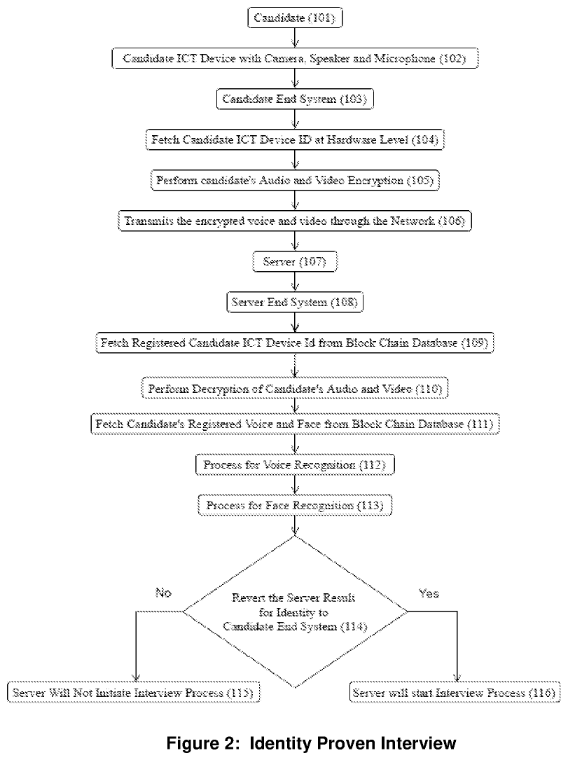

FIG. 2: Identity Proven Interview

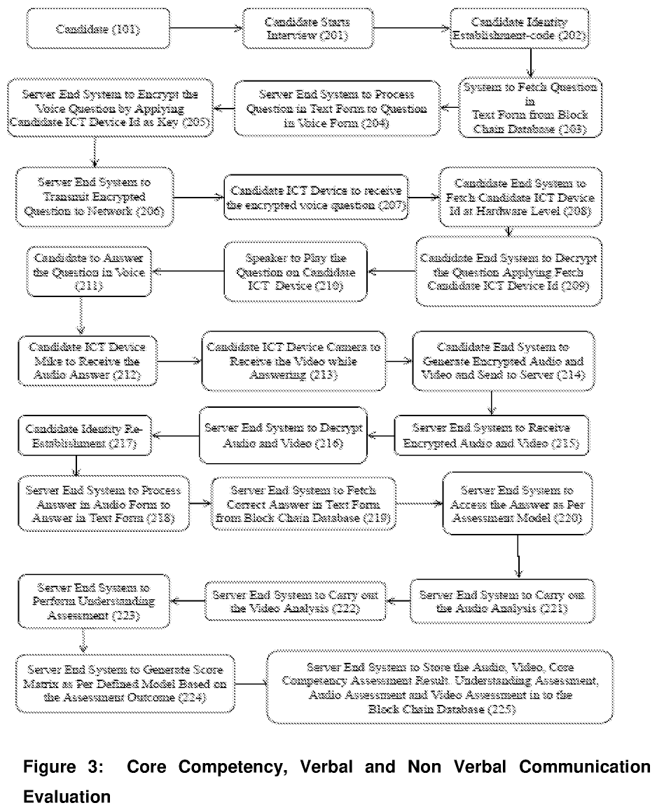

FIG. 3: Core Competency, Verbal and Non Verbal Communication Evaluation

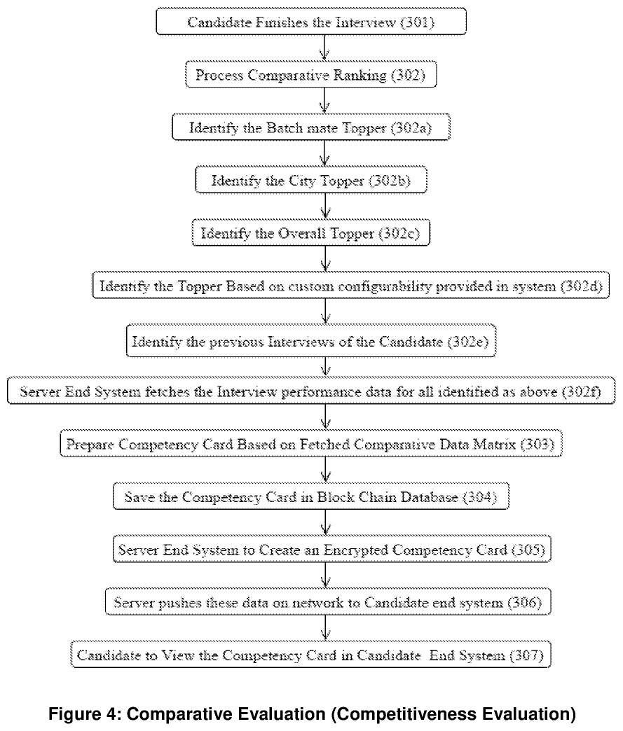

FIG. 4: Comparative Evaluation (Competitiveness Evaluation)

### DESCRIPTION OF DRAWINGS

FIG. 1 illustrates Registration of Candidate, where the Candidate (101) starts using the Candidate ICT Device with Camera, Speaker and Microphone (102). Candidate (101) invokes Candidate End System (103) to register its own identity. For this the Candidate End System (103) first Fetches Candidate ICT Device ID at Hardware Level (104). After which Candidate has to read and speak the content displayed on the screen (104 (a)). Based on which the Candidate End System records voice and video of the candidate while speaking the content (104 (b)). Further the Candidate End System (103) transmits Voice, video and Candidate ICT Device id through Network (104 (c)) to the Server (107), which is further received by the Server End System (108). Then the Candidate ID (101 (a)) is created by the Server End System as Unique Identity (108 (c)). Further the Server End System (108) Stores the received Candidate ICT Device Id to the Block Chain Database (108 (a)). The Server End System (108) also Stores Candidate Audio and Video in the Block Chain Database (108 (b)) along with candidate id for future access and retrieval.

FIG. 2 illustrates Identity Proven Interview. Candidate (101) starts using Candidate ICT Device with Camera, Speaker and Microphone (102). Further the Candidate (101) invokes Candidate End System (103) to establish its own identity. For this Candidate End System (103) first Fetches Candidate ICT Device ID at Hardware Level (104). The Candidate End system (103) asks candidate ID (101 (a)) as input and then to read text displayed on the screen. Candidate End System (103) Captures Audio and Video of candidate while reading the text.

The Candidate End System (103) further uses this unique device id as key and Perform Encryption of Candidate's Audio and Video (105). Once this is done, the Candidate End System (103) transmits the encrypted voice and video through the Network (106), which is further received by the Server End System (108) on the Server (107). The Server End System (108) further fetches Registered Candidate ICT Device ID from block chain database (109) using Candidate ID (101 (a)) to enable the decryption process. The Server End System (108) Performs the decryption of candidate's Audio and Video (110). To establish the candidate's identity, the Server End System (108) Fetches the Candidate's Registered Voice and Face from the Block Chain Database (111) and performs the Process for Voice recognition (112) and Process for Face Recognition (113).

Based on the recognition result outcome, the Server End System (108) Reverts the Server Result for Identity to the Candidate End System (114) and if the identity is not established, Server will not initiate the interview process (115) and if identity is matched with the identity registered on the Server (107) as stored in the Block Chain Database (108 (d)), then the Server will start Interview Process (116).

FIG. 3 illustrates Core Competency, Verbal and Non Verbal Communication Evaluation. Server End System (108) sends alert to the Candidate (101) to start the interview as per the scheduled interview timing. The Candidate (101) opens up the system and Candidate Starts Interview (201). First of all, Candidate Identity Establishment (202) is performed as described under FIG. 2 description, so that system allows the Candidate (101) to continue the interview process.

Based on the configured parameter for the Server End System (108), the System Fetch Question in Text Form from the Block Chain Database (203). The Server End System to Process Question in Text Form to Question in Voice Form (204). Further the Server End System encrypts the Voice Question by Applying Candidate ICT Device Id as Key (205). The Candidate ICT device id is already available with Server End System (108) as it has been fetched from the Block Chain Database (108 (d)) at the time of establishing candidate's identity. The Server End System to Transmit Encrypted Voice Question to Network (206). Further the Candidate ICT Device Receives the Encrypted Voice Question (207). Then Candidate End System Fetches Candidate ICT Device Id at Hardware Level (208). Further Candidate End System Decrypts the Question by Applying Fetched Candidate ICT Device Id (209). Then the Candidate End System (103) pushed an unencrypted Question to the Device Speaker to Play the Question on the Candidate ICT Device (210).

Then the Candidate (101) Listens the question and the Candidate gives a response to the question in voice (211). Candidate ICT Device Mike to Receive the Audio Answer (212). The Candidate ICT Device Camera Receives the Video While Answering (213). Then the Candidate End System performs Encryption of Audio and Video using Candidate ICT Device Id and Sends encrypted audio and video to Server (214).

The Server End System to receive Encrypted Audio and Video (215). Server End System to Decrypt Audio and Video (216) using candidate ICT device id stored in Block Chain Database (108 (d)) when candidate's identity was registered.

Candidate identity is Re-Established (217) by Server End System (108). Then the Server End System to process Answer in Audio Form to Answer in Text Form (218).

If the answer by Candidate (101) is not about any from: repeat the question, clarify the question or skip the question, then the Server End System (108) further processes the said answer.

Further the Server End System Fetches Correct Answer in Text Form from Block Chain Database (219). Further Server End System is Assessing the Answer as Per Assessment Model (220), also the Server End System (108) Carries out the Audio Analysis (221) and Carries out the Video Analysis (222). Based on which the Server End System Performs Understanding Assessment (223). Server End System Generates Score Matrix as Per Defined Model Based on the Assessment Outcome (224). Then the Server End System Stores the Audio, Video, Core Competency Assessment Result, Understanding Assessment, Audio Assessment and Video Assessment into the Block Chain Database (225).

FIG. 4 illustrates Comparative Evaluation (Competitiveness Evaluation). Once the Candidate Finishes interview (301), the Server End System (108) Processes Comparative Ranking (302). In this process the Server End System (108) first identifies different toppers. First the Server End System (108) Identifies Batch Mate Topper (302 (a)). Then the Server End System (108) identifies the city of the candidate and then Identifies the City topper (302 (b)). Finally, the Server End System (108) identifies the Overall topper (302 (c)) and like the same, others can also be identified as configured in the system as per the need of the user. Server End System (108) identifies the topper based on custom configurability provided in the system (302 (d)). The Server End System (108) also fetches data for all the previous interviews of the candidate (302 (e)). Once toppers' candidate ids are available, the Server End System fetches interview performance data for all identified as above (302 (f)) from the Block Chain Database (108 (d)). Further the Server End System (108) Prepares Competency Card based on the Fetched Comparative Data Matrix (303). This data Matrix is presented in anonymous mode to retain the privacy of the respective topper candidate. Then the Server End System (108) Saves the Competency Card in the Block Chain Database (304), then the Server End System Creates an Encrypted Competency Card (305). Server pushes these data (Encrypted Competency Card) on the network to Candidate end system (306) and thus Candidate can view own performance mentioned in the Competency Card through Candidate End System (307).

### DETAILED DESCRIPTION OF THE INVENTION

Present novel invention is simulating completely real life environment which replaces human aspect of interview panel and candidate still feels that interview is conducted as intelligently as human is conducting interview, this allows him to seek clarification of question, request for repetition of question in case of ambiguity and request for skipping the question if one doesn't know the answer.

The present novel invention Automated Recruitment Interview Performance Assessment System, is an interview performance assessment automated system in which Candidate (101) starts using Candidate ICT Device with Camera, Speaker and Microphone (102). Candidate (101) invokes Candidate End System (103) to register its own identity. For this Candidate End System (103) first Fetches Candidate ICT Device ID at Hardware Level (104). After which Candidate has to read and speak the content displayed on the screen (104 (a)). Based on which Candidate End System (103) records voice and video of candidate while speaking the content (104 (b)). Further the Candidate End System (103) transmits Voice, video and candidate ICT Device Id through Network (104 (c)) to the Server (107) which is received by Server End System (108). Then the Candidate ID is created by the Server End System as Unique Identity (108 (c)). Further the Server End System (108) Store Registered Candidate ICT Device Id to Block Chain Database (108 (a)) and also Store Candidate Audio and Video in Block Chain Database (108 (b)) as shown in FIG. 1.

Data is sent from Candidate ICT Device with Camera, Speaker and microphone to Server in encrypted form using the Device id. Candidate ICT Device id is fetched at the hardware level. Questions asked by the Candidate End System will be encrypted by the Candidate ICT device id stored at the Server and the same will be decrypted by the Candidate End System using its own Candidate ICT device id. When the Candidate will reply to asked questions, the voice and video of the Candidate will be encrypted by the Candidate ICT device id fetched at the hardware level from the Candidate ICT Device with Camera, Speaker and microphone used by the Candidate for interview and will be streamed to Server. The Server will Perform Decryption of Candidate's Audio and Video using the candidates registered ICT device id stored at the Block Chain Database. Thus specific devices will only be able to ‘understand’ interaction from the server and the server will clearly understand which device has initiated the conversation. Thus any interception of the content from the network will not be meaningful for any unauthorized device.

Candidate (101) identity is established by combination of the Process for Voice Recognition (112) and the Process for Face Recognition (113) by matching with registered voice and face at the time of registration process. Additionally, the device used for the interview by the Candidate (101) is the same or not is also verified using Candidate ICT Device Id eg IMEI Number, CPU Id, MAC Address etc. Then the Candidate (101) starts using the Candidate ICT Device with Camera, Speaker and Microphone (102). Further Candidate (101) invokes Candidate End System (103) to establish its own identity. For this Candidate End System (103) first Fetches Candidate ICT Device ID at Hardware Level (104). The Candidate End System (103) further uses this unique Candidate ICT Device ID as key and Perform Candidate's Audio and Video Encryption (105). Once this is done the Candidate End System (103) Transmits the encrypted voice and video through the Network (106) which is received by Server End System (108) on the Server (107). The Server End System (108) further Fetch Registered Candidate ICT Device ID from Block Chain Database (109) to enable the decryption process. The Server End System (108) Performs decryption of Candidate's Audio and Video (110). To establish the candidate's identity, the Server End System (108) Fetch the Candidate's Registered Voice and Face from Block Chain Database (111) and perform the Process for Voice Recognition (112) and then Process for Face Recognition (113) as shown in FIG. 2.

Based on the recognition result outcome, the Server End System shares the result to the Candidate End System to establish Candidate Identity and if the identity is not established, Server will not Initiate the Interview Process and if identity is matched then the Server End System will start the Interview Process. This ensures full data privacy and data security based interaction between Server and specific device for specific Candidate. This fulfills the fundamental requirement that no one can face the interview with fake identity as registered candidate's identity in online mode.

Server End System (108) sends alert to the Candidate (101) to start the interview as per the scheduled interview timing. The Candidate (101) opens up the system and Candidate Starts Interview (201). First of all, Candidate Identity Establishment (202) is performed as described under FIG. 2 description, so that system allows Candidate (101) to continue the interview process. Based on the configured parameter for the Server End System (108) it Fetches the Question in Text Form from Block Chain Database (203). Then the Server End System Processes Question in Text Form to Question in Voice Form (204). Further, the Server End System Encrypts the Voice Question by Applying Candidate ICT Device Id as Key (205). Candidate ICT device id is already available with Server End System (108) as it has been fetched from the Block Chain database (108 (d)) at the time of establishing candidate's identity. The Server End System (108) transmits Encrypted Question in Voice Form to Network (206). Then the Candidate ICT Device Receives the Encrypted Voice Question (207) and the Candidate End System Fetches the Candidate ICT Device Id at Hardware Level (208).

Then the Candidate End System Decrypts the Question Applying Fetched Candidate ICT Device Id (209), and then the Candidate End System (103) pushes an unencrypted Question to Device Speaker to Play the Question on Candidate ICT Device (210). Candidate (101) listens to the question and gives the answer of said question in voice (211). Candidate ICT Device Mike Receives the Audio Answer (212), Candidate ICT Device Camera Receives the Video While Answering (213) based on which the Candidate End System (103) generates Unique Id and performs Encryption of Audio and Video using Candidate End System to generate Encrypted Audio and Video and send to Server (214) on the network. Server End System to Receive Encrypted Audio and Video (215) then the Server End System Decrypts Audio and Video (216) using candidate ICT Device unique id stored in the Block Chain Database (108 (d)). Candidate identity is Re-Established (217) by Server End System (108). Then the Server End System Processes Answer in Audio Form to Answer in Text Form (218). Further Server End System to Fetch Correct Answer in Text Form from the Block Chain Database (219) and Assess the Answer as Per Assessment Model (220). Server End System to Carry out the Audio Analysis (221) and the Video Analysis (222). Based on which the Server End System to Perform Understanding Assessment (223) as shown in FIG. 3.

Core competency is assessed purely based on the content of the answers for the questions asked by the system. System will identify the phrases used in the answer and it is matched with the Model Answer phrases. System will check whether Phrases used in answers are identified as part of Correct answer, Wrong Answer phrases, Irrelevant phrases (i.e. not related to asked question at all), or not part of a set of any phrases.

On the other hand, candidates' detailed profiles will be captured in the system at the time of registration. Based on the role wise experience profile, difficulty level of questions will be selected by the system. This will enable to increase the effectiveness of the performance evaluation of the interview.

There will not be any extra questions asked but candidate voice and video gets analysed in parallel thread by system for the interaction carried out. Non Verbal Communication also has equal importance, so it is done in three distinct categories as per following details.
1. Verbal
   a. Verbal Content—Score gained in the core competence through verbal content
   b. Verbal Language—Grammar, Quality of pronunciation
2. Non Verbal
   a. Voice based—Voice Quality Volume (Loudness), Pitch (Rise and Fall), Pace (Rate), Pause (Silence), Resonance (Timbre), Intonation.
   b. Gesture based—Eye Contact, Hand Movement, Head Movement, Body Posture
3. Understanding
   a. Number of questions explanations were requested
   b. Number of questions were asked to repeat
   c. Number of Questions skipped

Lip-reading recognition technology will be implemented additionally to create a better quality of the listening.

Actual values will be found out and stored in Block Chain Database. Importance given to each parameter are configurable as for each role each aspect has different importance. System fetches these parameters and performance level will be shown. This will be like a pathological report where standard ranges are shown in brackets for reference and the assessment values are shown for self-understanding about the status.

Server End System (108) will generate a score for the given answer by getting addition for the values identified against each of the defined categories for each question in the Block Chain Database (108 (d)). Pre-Defined Assessment Model is as under; however, this is configurable as per requirement of the organization. Present novel invention also addresses the need for specific interview requirements to set its own benchmark for assessment of candidates as per their specific norms/requirements.
(1) Mandatory Phrase has higher score than Key Phrase
(2) There will be negative score for all the phrases which are mandatory and not part of the reply of answer given by the candidate
(3) Normal phrase has less score compare to Key phrases
(4) Irrelevant phrases have negative score
(5) Wrong phrases have higher negative score than irrelevant phrase
(6) Not part of set of any phrases will be neutral and no score will be added or deducted

Based on each interview, this score matrix is stored in a Block chain database (108 (d)) with a breakup. This is displayed in the interview transcripts generated at the end of the interview. Server End System to Generate Score Matrix as Per Defined Model Based on the Assessment Outcome (224). Then the Server End System Stores the Audio, Video, Core Competency Assessment Result, Understanding Assessment, Audio Assessment and Video Assessment into the Block Chain Database (225).

In all the traditional systems these are available as there is no option given to know the performance of the Interview by candidate. Once the Candidate finishes the interview (301), the Server End System (108) Processes comparative ranking (302). In the present novel process, the Server End System (108) first identifies different toppers. The Server End System (108) Identifies Batch Mate Topper (302 (a)). Then the Server End System (108) identifies the city of the candidate and then Identifies City topper (302 (b)). Finally, the Server End System (108) Identifies overall topper (302 (c)) and like the same, others can also be identified as per the need of the user. Server End System (108) identifies the topper based on the custom configurability provided in system (302 (d)). The Server End System (108) also fetches data for all the previous interviews of the candidate (302 (e)). It also offers comparative performance of candidate's interview with peers in the Institute from the same batch, other institutes from the same city, with peers from other organisations with matching skills, Toppers in the complete database for this year, senior batches students for the same set etc. Once topper candidate's ids are available, the Server End System fetches interview performance data for all identified as above (302 (f)) from Block chain database (108 (d)). Further the Server End System (108) prepares competency cards based on the Fetched Comparative Data Matrix (303). Then the Server End System (108) Saves Competency Card in Block Chain Database (304) and said Server End System Creates an Encrypted Competency Card (305). Using the Server end system (108) Server pushes these data on the network to Candidate end system (306) which is in encrypted form. Candidates can View the Competency Card in Candidate End System (307) as shown in FIG. 4. Toppers data is presented in anonymous mode to retain privacy of the respective candidate.

The present novel system also offers comparative performance ranking of a candidate's own multiple interview. All the data related to scoring and verbal as well as nonverbal communications are presented in matrix form for self-evaluation. This really adds value as in each round of interview for the same role by the same candidate only certain percentages of questions from the previous round gets repeated. This is achieved by maintaining a question set already asked to candidates in each round in the block chain database.

For the present invention description, the Candidate ICT Device, Candidate End System, Server, Server End System is to be considered as a computing device, such as a smartphone, tablet computer, laptop, or any other device that can communicate over the network. In various implementations, the said computing device may comprise a laptop, a notebook, an Ultrabook, a smartphone, a tablet, a personal digital assistant (PDA), an ultra-mobile PC, or a mobile phone. In further implementations, the said ICT device may be any other electronic device that processes data. Wherein the processor is coupled to a chipset. Also coupled to the chipset are a memory, a storage device, a graphics adapter, and a network adapter. Wherein the display is coupled to the graphics adapter. The memory can include any one or combination of volatile memory elements (e.g., random access memory (RAM, such as DRAM, SRAM, SDRAM, etc) and non-volatile memory elements (e.g., ROM, hard drive, tape, CDROM, etc.). Moreover, the memory may incorporate electronic, magnetic, optical, and/or other types of storage media. The memory can have a distributed architecture, where various components are situated remotely from one another, but can be accessed by the processor. The processor is a hardware device for executing software, particularly that stored in the memory. The processor can be any custom made or commercially available single core or multi-core processor, a central processing unit (CPU), an auxiliary processor among several processors associated with the present system, a semi-conductor based microprocessor (in the form of a microchip or chip set), a macro processor, or generally any device for executing software instructions.

For the present invention description, the Network is to be considered as, a network that may be any suitable communications network for data transmission. In an embodiment such as that illustrated in figures, the network uses standard communications technologies and/or protocols and can include the Internet. In another embodiment, the entities can use custom and/or dedicated data communications technologies.

We claim:

1. An Automated Recruitment Interview Performance Assessment System, which provides identity proven comparative evaluation of candidates is comprising of:
at least one and more of a Candidate (101), a Candidate End System (103), a Candidate ICT Device with Camera, Speaker and Microphone (102), a Server (107), a Server End System (108), and a Block Chain database (108 (d));
wherein registration of the Candidate (101) is comprising of at least one and more of the following steps:
in first step, the said Candidate (101) joins using the said Candidate ICT Device with Camera, Speaker and Microphone (102);
in further step (104), the said Candidate End System (103) Fetches the Candidate ICT Device ID at Hardware Level;
in further step (104 (a)), the said Candidate (101) has to read and speak the content displayed on the screen;
in further step (104 (b)), the said Candidate End System (103) records voice and video of candidate while speaking the content;
in further step (104 (c)), the said Candidate End System (103) Transmits the Voice, Video and Candidate ICT Device Id through Network;
in further step (106), the said Candidate End System (103) perform Candidate's Audio and Video Encryption (105) and Transmits the encrypted voice and video through the network to the said Server (107);
in further step (108 (c)), the said Server End System (108) creates Candidate ID (101 (a)) as unique identity;
in further step (108 (a)), the said Server End System (108) Stores Registered Candidate ICT Device Id to the said Block Chain Database (108 (d));
in further step (108 (b)), the said Server End System (108) Stores Candidate Audio and Video in the said Block Chain Database (108 (d));
wherein for the Identity Proven Interview of the said Candidate (101), the said system is further comprising of at least one and more of the following steps:
in first step, the said Candidate (101) joins for the interview using the said Candidate ICT Device with Camera, Speaker and Microphone (102);
in further step (104), the said Candidate End System (103) Fetches the candidate ICT Device ID at hardware level;
in further step (106), the said Candidate End System (103) perform Candidate's audio and video encryption (105) and transmits through the network, to the Server (107);
in further step (109), the said Server End System (108) Fetches registered Candidate ICT device Id from the said Block Chain Database (108 (d));
in further step (110), the said Server End System (108) performs decryption of candidate's audio and video from the said Block Chain Database (108 (d));
in further step (111), the said Server End System (108) Fetches candidate's registered voice and face from the said Block Chain Database (108 (d)) and Processes for the voice recognition (112) and Processes for face recognition (113);
in further step (114), the said Server End System (108) Revert the Server Result for Identity to the said Candidate End System (103); and
in further step, if the identity of the said Candidate (101) is matched by the said Server End System (108) the said Server (107) will start interview process (116), and if the identity of the said Candidate (101) is not matched by the said Server End System (108) the said Server (107) will not Initiate Interview Process (115).

2. An Automated Recruitment Interview Performance Assessment System, having a good processor and technology capable of providing compute, storage, network, AI/ML, Blockchain, Processing Natural Languages, Audio streams and video streams, implementing a comprehensive assessment model for evaluating candidates, comprising:
two assessment categories, wherein Category A is for candidates using the model as a rehearse platform with parameter values decided by the model's configurator, and Category B is for companies using the model for recruitment purposes with parameter values defined by the client company's configurator for each role;
multiple answer variants including (i) voice-based answers communicated through narration, (ii) diagram, graph, or chart-based answers prepared using an online integrated tool or drawn on paper and submitted, (iii) tabulated numerical calculations submitted either scanned from paper or prepared using an online integrated tool, and (iv) code development answers submitted and evaluated through an integrated platform for quality and correctness;
selection of company type level affecting question difficulty and accuracy levels for local companies, national companies, multi-national companies, and top brands in the candidate's domain:
a score matrix model evaluating correctness of the answer, time taken to answer, voice quality, gesture level, and a challenge and earn special credit mechanism;
correctness of the answer evaluated by matching content from the voice-based answer with the model answer stored in an immutable blockchain database, identification of mandatory phrases from the model answer with scoring based on presence or absence of mandatory phrases, use of non-relevant phrases, and use of synonyms attracting lower scores compared to exact phrases;
predefined ideal time for answering with additional time resulting in lower scores;
verbal language quality assessment including analysis of volume, pitch, pace, pause, resonance, and intonation; gesture analysis based on eye contact, hand movement, head movement, and body posture.

3. An Automated Recruitment Interview Performance Assessment System, having a good processor and technology capable of providing compute, storage, network, AI/ML, Blockchain, Processing Natural Languages, Audio streams and video streams, generating Competency Card of a candidate based on score matrix offered by an assessment model of claim 2, comprising:
Generating and Storing unique Competency Card in Blockchain system in immutable form offering highest trust level to viewer;
defining competency level as per the score matrix generated by the Assessment model of claim 2 according to a uniquely defined competency Level;
Offering a link of competency card which can be access from Blockchain system to prospective employer as replacement of CV;
Offering competitiveness evaluation of candidate's interview with peers in the Institute from the same batch, other institutes from the same city, toppers in the complete database for the same year student, senior batches students for the same set of parameters;
Offering Comparative performance of a candidate's own multiple interview for one role.

4. The Automated Recruitment Interview Performance Assessment System as claimed in claim 1, wherein for the Comparative or Competitive Evaluation of the Candidate (101) is performed based on at least one and more of the following steps:
in first step (301), the said Candidate (101) finishes the interview;
in further step (302), the said Server End System (108) processes comparative ranking;
in further step, the said Server End System (108) identifies at least one and more of the Batch Mate Topper (302 (a)), the City topper (302 (b)), the Overall topper (302 (c)) and like based on the custom configurability provided (302d) in the Server End System (108) by the user;
in further step (302 (e)), the said Server End System (108) identifies previous interviews of the Candidate (101);
in further step (302 (f)), as toppers' Candidate ids (101 (a)) are available, the said Server End System (108) fetches interview performance data for all previous interviews of the said Candidate (101);
in further step (303), the said Server End System (108) Prepares competency card based on fetched comparative data matrix;
in further step (304), the said Server End System (108) Saves the competency card in the said Block Chain Database (108 (d));
in further step (305), the said Server End System (108) Creates an encrypted competency card;
in further step (306), the said Server End System (108) pushes the encrypted competency card via network to the Candidate end system (306);
In further step (307), the said Candidate (101) can view the encrypted competency card on the said Candidate End System (307) by decrypting it based on Candidate ICT Device ID.

5. The Automated Recruitment Interview Performance Assessment System as claimed in claim 4,
wherein the competency card of the Candidate (101) is based on the fetched comparative data matrix (303) prepared by the Server End System (108) based on either one and more of the Batch Mate Topper (302 (a)), the City topper (302 (b)), the Overall topper (302 (c)), previous interviews of the Candidate (302 (e)) and like based on the custom configurability provided (302d);
wherein the Candidate (101) can replay the own previous interviews for self-analysis of Core Competency, Verbal and Non Verbal Communication Evaluation.

6. An ICT System for assessing a candidate's performance across multiple roles, comprising:
performing more than one role interview with the candidate;
storing the results of the multiple role interviews in a database for each category of the assessment model of claim 2;
generating a comparative statement in the form of matrix keeping role on x axis and segments of assessment model of claim 2 on Y axis based on the stored results;
providing a detailed analysis to enable the candidate to understand own strengths and weaknesses through assessment model criteria;
offering a recommendation system to assist the candidate in determining which role they can perform better based on the analysis;
evaluating the candidate's proficiency level in their aspirational role using a predefined assessment framework;
identifying specific areas for improvement through the resultant score matrix, which is generated by comparing the candidate's performance against set benchmarks.

7. The Automated Recruitment Interview Performance Assessment System as claimed in claim 1,
wherein the Server End System (108) selects the appropriate difficulty level of questions, based on the type of company, type of Candidate (101) (e.g. fresher or experienced) and job role applied by the Candidate (101);
Wherein the recruiting companies are able to define and configure at least one and more of the whole set of questions, answers, key words and phrases specific to said questions and answers, score/ranking for each of the said phrases, evaluation methods, range for the verbal and non-verbal assessment for their personalised and customised need.

8. The Automated Recruitment Interview Performance Assessment System as claimed in claim 1, wherein the voice and video of the Candidate (101) gets analysed continuously in parallel thread by the Server End System (108).

9. The Automated Recruitment Interview Performance Assessment System as claimed in claim 1, wherein the Score Matrix of the Assessment Outcome (224) is configurable model to generate a score for the given answer by getting addition for the values identified against each of the defined categories for each question as stored in the Block Chain Database (108 (d)).
